(19) United States
(12) Patent Application Publication
(10) Pub. No.: US 2010/0312755 A1
(43) Pub. Date: Dec. 9, 2010

(54) METHOD AND APPARATUS FOR COMPRESSING AND DECOMPRESSING DIGITAL DATA BY ELECTRONIC MEANS USING A CONTEXT GRAMMAR

(76) Inventors: Eric Hildebrandt, Frankfurt (DE); Martin Bokler, Fraenkisch-Crumbach (DE)

Correspondence Address: DARBY & DARBY P.C., P.O. BOX 770, Church Street Station, New York, NY, 10008-0770, US

(21) Appl. No.: 12/444,434

(22) PCT Filed: Jul. 24, 2007
(86) PCT No.: PCT/DE2007/001311

§ 371 Date: Mar. 12, 2010

(30) Foreign Application Priority Data
Oct. 7, 2006 (DE) 102006047465.1

(51) Int. Cl. G06F 17/30

(52) U.S. Cl. 707/693; 707/E17.002

(57) ABSTRACT

A method for electronically compressing and decompressing digital data using a context grammar includes grammatically compressing first digital data by discovering multiply occurring sequences of non-further-factorizable terminal symbols in the first digital data and replacing the discovered multiply occurring sequences of non-further-factorizable terminal symbols with non-terminal symbols that can be further factorized. Digital data belonging to the non-terminal symbols is stored in a context grammar. Second digital data is compressed using the context grammar. The first digital data relates to a column of data stored in a database and the second digital data relates to entries in the column of data stored in the database.

### CROSS REFERENCE TO RELATED APPLICATIONS

This application is a U.S. National Phase application under 35 U.S.C. §371 of International Application No. PCT/DE2007/001311, filed Jul. 24, 2007, and claims benefit to German patent application DE 10 2006 047 465.1, filed Oct. 7, 2006. The international Application was published in German on Apr. 10, 2008 as WO 2008/040267A1 under PCT Article 21 (2).

### FIELD

The invention relates to a method and device for the compression and decompression of digital data by electronic means using a context grammar and relates more particularly to a method and system for the highly efficient and fast, lost-free compression of data for short, redundancy-containing data records.

### BACKGROUND

The compression of digital data by electronic means, i.e. in an electronic system for information processing or data transfer, is used above all to economize on storage space and transmission capacity. Especially in cases where large volumes of digital data are transferred over data networks, compression is important not only for the efficient use of existing transmission capacities, for example of available bandwidth, but also in order to speed up the data transfer process. Yet also in relation to the storage of large volumes of digital data of the order of gigabytes or even terabytes, such as in databases, efficient compression is frequently necessary in order to reduce the amount of storage space that would be required for the uncompressed digital data, thereby making it possible to economize on technical resources.

The loss-free compression of data (data compression) is frequently accomplished using the algorithms of Huffmann and of Ziv and Lempel (LZ). In widespread use, for example, are the LZ77 and LZ78 algorithms, which are named after the years of their publication and which are described in the articles “A Universal Algorithm for Sequential Data Compression”, J. Ziv, A. Lempel, IEEE Transactions on Information Theory 23 (1977), pp. 337-343, and “Compression of Individual Sequences via Variable Length Coding”, J. Ziv, A. Lempel, IEEE Transactions on Information Theory 24 (1978), pp. 530-536. The Huffmann algorithm is described in the article “A Method for the Construction of Minimum Redundancy Codes”, Huffmann, D. A., Proceedings of the Institute of Radio Engineers, September 1952, Vol. 40, No. 9, pp. 1098-1101.

In the LZ77 algorithm, identical symbol sequences in a symbol string that is to be compressed are not stored more than once, but a relationship is established with a first occurrence of a symbol sequence, the relationship indicating how many symbols to go back in the sequence and the length of the sequence that is to be repeated. The LZ78 algorithm creates a table with frequently occurring symbol sequences. If such a symbol sequence occurs in a symbol string that is to be compressed, it is necessary simply to insert the corresponding code from the table, which is shorter than the symbol sequence itself.

A further development of the LZ78 algorithm is the LZW algorithm, which is described in the article “A Technique for High-Performance Data Compression”, Welch, T. A., IEEE Computer, Vol. 17, No. 6 (1984), pp. 8-19. The LZW algorithm, like the LZ78 algorithm, is a table-based compression method. The basis is provided by a predetermined table with 256 entries, which is extended in the course of the compression operation according to the requirements of the symbol sequence that is to be compressed. As soon as one of the symbol sequences in the table occurs in the symbol sequence that is to be compressed, it can be replaced by the table index. The LZW algorithm is used, for example, for data compression in modems and in computer systems for the storage of GIF and TIFF files. U.S. Pat. No. 4,558,302 describes the LZW algorithm in detail.

The aforementioned algorithms are all window-based compression methods in which, owing to limited resources, such as storage restrictions, a so-called window of predetermined width is moved over the data to be compressed and the data inside the window are compressed. In this connection, the windows used in the algorithms can be initialized, so that any sequences in the data to be compressed that occur in said initialization can be cited directly upon first occurrence, thereby resulting in compression.

Window-based methods are disadvantageous inasmuch as it is possible to interlink only those text passages whose distance from each other is smaller than the width of the window.

In addition, the following algorithms are related to the grammatical compression of digital data:

Sequitur: described in “identifying hierarchical structure in sequences: A linear-time algorithm”, C. Nevill-Mannig, I. Witten, Journal of Artificial Intelligence Research, 7:67-82, 1997; and
Repair: “Offline dictionary-based compression”, N. J. Larsson, A. Moffat, Proceedings of the IEEE, vol. 88, no. 11, pp. 1722-1732

### SUMMARY

In an embodiment, the invention provides a method and apparatus for electronically compressing and decompressing digital data using a context grammar The method includes grammatically compressing first digital data by discovering multiply occurring sequences of non-further-factorizable terminal symbols in the first digital data and replacing the discovered, multiply occurring sequences of non-further-factorizable terminal symbols with non-terminal symbols that can be further factorized. Digital data belonging to the non-terminal symbols is stored in a context grammar Second digital data is compressed using the context grammar. The first digital data relates to a column of data stored in a database and the second digital data relates to entries in the column of data stored in the database.

### DETAILED DESCRIPTION

In an embodiment, the present invention provides a method and device for the compression and uncompression of digital data by electronic means allowing the fast and efficient compression and uncompression of short, redundancy-containing data.

An embodiment of the present invention relates to a method for the compression and decompression of digital data by electronic means using a context grammar, including the steps of grammatical compressing first digital data by finding multiply occurring sequences of non-further-factorizable terminal symbols (V_T) in the first digital data to be compressed; replacing discovered, multiply occurring sequences of non-further-factorizable terminal symbols (V_T) with further-factorizable non-terminal symbols (V_N); storing the digital data belonging to said non-terminal symbols (V_N) in an appropriate context grammar; and executing context compression by which second digital data are compressed using said context grammar produced from the first digital data.

In one embodiment, the step of producing a grammar is such that given as a derivation is a mapping for each symbol from the set of non-terminal symbols (V_N) onto a symbol from the set of non-terminal symbols (V_N) in union with the set of terminal symbols (V_T).

In another embodiment, a step whereby production of a start symbol (S0) whose derivation corresponds to a text to be compressed is executed may be included.

The second digital data may be similar to the first digital data.

In an embodiment, when the rules of the produced grammar are imported, expansions of said rules are stored in a tree structure, wherein the tree structure may be expandable with new rules obtained from the second digital data.

In another embodiment, for context compression, the tree structure is run through symbol by symbol in ascending order and a search is made for a grammar rule corresponding to a longest prefix, for which grammar rule there is a tree path starting from its root.

For context compression, a search may be made for the most frequently occurring grammar rules or the grammar rules with the longest derivation.

To produce the grammar, algorithms according to Sequitur, Sequential or Repair may be used.

In yet another embodiment, the produced grammar is additionally arithmetically coded or coded using a Huffman code.

A computer program for the compression and decompression of digital data by electronic means using a context grammar of the above may be executed on a data-processing system such as a computer.

Such a computer program is may be in the form of a computer-program product that comprises a machine-readable data medium on which a computer program is stored in the form of electronically or optically readable control signals for a computer.

A device for the compression and decompression of digital data by electronic means using a context grammar, with an input means, a processing means, a storage means and an output means for implementation of the aforementioned method serves for practical implementation of the method according to an embodiment of the invention.

The method according to an embodiment of the invention for the compression and decompression of digital data by electronic means using a context grammar is particularly efficient for the compression of data records of databases, more particularly of relational, object-oriented and XML-based databases. For example, a context grammar can be created for a table column, and the column entries can then be compressed using the context grammar.

Furthermore, the method according to an embodiment of the invention for the compression and decompression of digital data by electronic means using a context grammar is suitable for the compression of a data transfer, more particularly a point-to-point connection. This makes it possible to increase the effectively usable bandwidth of a data connection. The relatively short data packets of the kind that occur especially often in data transfers are suitable for context compression. More particularly, the packet structures of digital data for transfer can be compressed prior to data transfer using a context grammar available at both points of transmission.

Finally, the method according to an embodiment of the invention for the compression and decompression of digital data by electronic means using a context grammar can also be used for the compression of a file or of two or more files of the same type, more particularly of XML files.

In accordance with an embodiment of the present invention, during the compression of first data, information is obtained that can be used for the efficient compression of second data similar to the first data. In other words, the information obtained from the first data can be efficiently used.

Expressed more precisely, during the compression of the first data, a context grammar is produced which can then be used to compress the second and also additional data. In other words, during the compression of the first data, information is obtained that is then used to compress second data.

The grammar produced during compression of the second data contains, in particular, a special rule, which is referred to below for short as the start rule and the expansion of which corresponds to the data to be compressed. While this start rule is generally characteristic of the data record that is to be compressed, further rules, which are “inserted” into the start rule following the context grammar, tend to be of a general nature. Consequently, the information obtained from similar data is used as the basis for producing the grammar used for the compression of further data currently to be compressed. For yet further, improved compression, the symbols of the grammar can then be coded, for example, by means of Huffman codes or arithmetically.

An embodiment of the invention is characterized by the following points:
1. The grammar-based compression method allows rules to be used independently of their position in the grammar and the data. As was mentioned hereinabove, window-based methods, on the other hand, can interlink only those text passages whose distance from each other is smaller than the width of the window. This is highly disadvantageous especially in the case of large volumes of similar data records of the kind that occur, for example, in the columns of databases.
2. The quantity of information to be used for the context grammar can be flexibly selected in extremely simple manner, for example depending on the application, data type and data volume.
3. The context information can be extracted directly from similar data in that, first, said data are compressed and the grammar thereby created for them is used without a start rule as the context grammar for other data. This takes place simultaneously and without additional effort and is, therefore, exceptionally efficient.
4. Greater flexibility is allowed in relation to coding, because the code of a grammar newly created for other data can be created and used independently of the code of the context grammar for the previously compressed data. This results in additional possibilities for further optimization.

Consequently, an embodiment of the invention allows for the efficient compression of small or short data records, which can either not be compressed or only compressed with significantly less efficiency using the known compression methods. This results, in the case of applications for such data records, in significant advantages with regard to the storage, transfer and processing of data.

The following description of example embodiments will present further advantages and possible applications of the present invention.

First of all, there is a description of the compression of data through the production of a context-free grammar according to an embodiment of the invention.

First, let V_{T} be the alphabet used in data that are to be compressed, such as the set of 256 possible character values or symbols, for example those of the extended ASCII code, which can be coded with one byte. The elements of V_{T} are referred to as terminals and indicate those symbols that cannot be further broken down or factorized.

The grammar to be produced for compression is then described by a set V_{N} of non-terminal symbols, i.e. variables, a special start rule S₀ and derivation rules S₁ to Sₙ. The derivation rules S₁ to Sₙ each contain a non-terminal symbol on the left-hand side and at least 2 symbols from V_{T} union V_{N} on the right-hand side.

This is to be illustrated by a short example. Let it be assumed, for example, that the text ABAB is to be compressed, where A and B are elements of V_{T}, i.e. non-further-factorizable terminals. When, now, a rule Sᵢ is produced using the instruction or grammar

S₁→AB

there result for the compressed text the start rule

S₀→S₁S₁

and the grammar S₁→AB, which, in this example, contains merely the mapping instruction for S₁ to AB.

The context-free grammar to be produced for data to be compressed can additionally be obtained by means of so-called context compression. In context compression, a multiplicity of (basic) rules K₁ to Kₙ is either predetermined or used from a previously created grammar, which can then be referenced to produce a new, context-free grammar from the data currently to be compressed. Therefore, the rules of context grammar K₁ to Kₙ can be used both to create new rules and also in start rule S₀.

After compression has been carried out by means of the context-free grammar, for further improvement of this first compression, a code is then used to store the grammar, wherein frequent symbols are assigned shorter code words than infrequent symbols. For this purpose, it is possible, for example, to use a Huffman code.

With regard to context compression, furthermore, there are various possibilities for coding, in particular, the rules of the context grammar
1. A first possibility consists in reusing the code words of the context grammar In this case, the entire context grammar is stored in coded form such that the employed code word lengths reflect the frequencies of occurrence of the corresponding expanded rules. Under the assumption that the data to be compressed are of the same type as, i.e. similar to, the data for producing the context grammar, the frequencies in the data to be compressed will be similar to the frequencies for producing the context grammar. Therefore, code words from the context grammar may be reused for coding the context rules.
   If new rules are additionally produced, these rules must have code words that have not yet been used for coding the context grammar. Once again, various possibilities are available for this purpose:
      a) According to one possibility, two codes are used simultaneously in connection with the aforementioned first possibility, i.e. in addition to the reused code words, a separate code is produced also for the newly produced, data-record-specific rules. Reused code words from the context grammar and code words from said newly produced code are then used for storing the compressed data.
         In this connection, there are various ways of determining which code the next code word belongs to:
            i) For example, one of the two codes has otherwise unused code symbols, which are used to identify one or more code words of the other code, or
            ii) Both codes each have an otherwise unused code word, which is used for switching to the other code.
      b) According to a further possibility in connection with the above first possibility, the code for the context grammar contains unused code words which serve as placeholders and which can be used for newly produced rules.
2. According to a second possibility, a common code is produced both for the reused rules of the context grammar and also for the newly produced rules. For this purpose, for a used context rule, it must be possible to establish an assignment to a new code word. This can be achieved, for example, in that the code word belonging to the context grammar rule is used to define the corresponding new code word.

The establishment of the assignment to the new code word is not restricted to the above-mentioned types, but can be selected in appropriately different manner according to the characteristics of the data to be compressed, in order to obtain as good a compression as possible.

Hereinbelow, the method according to an embodiment of the invention is described in further detail.

Starting out from an aspect of the invention, namely that information obtained during the compression of first digital data is used for the compression of second, similar digital data, the first digital data are first of all grammatically compressed.

Here, let V_T be the set of symbols used in the first digital data. During compression, a search is made in said data, for example a text, for sequences of terminal symbols V_T, i.e. non-further-factorizable symbols or characters, of which there is a multiple occurrence. Discovered symbols V_T are then replaced by a non-terminal symbol, i.e. a symbol that can be further factorized according to rules, and a subdata string, for example a subtext, belonging to that symbol is stored in a grammar containing rules. This results in a set of non-terminal symbols V_N.

In other words, for each symbol A from set V_N, the resulting grammar specifies to which symbols from V_N union V_T said symbol is mapped. This is referred to also as the derivation of (symbol) A.

More particularly, according to the present method, there is a special symbol S0 (start rule), the derivation of which corresponds to the data sequence that is to be compressed. If, for example, a text “a rose is a rose is a rose” is to be compressed, this can be represented in compressed form by the following grammar:

A→a rose

B→is A

S0→ABB

A context compression is then performed. In the context compression, similar, second digital data are compressed with the predetermined grammar produced from the first digital data. If the grammar produced from the first digital data was stored on a different path, this reduces the volume of data that needs to be stored for the compressed second digital data.

If, for example, the first digital data have been compressed and stored, and if second digital data similar to said first digital data are now to be compressed and stored, then, if the grammar produced for the first digital data is used, it already contains a multiplicity of rules that can be applied to the second digital data. In this manner, the second digital data can be compressed immediately.

The grammar can be produced in various ways, for example according to the Sequential, Sequitur or Repair methods. With reference to the example of Sequential, the following describes how a grammar can be efficiently used as a context grammar and be so imported that it can be used with little computation effort.

When the grammar rules are imported, expansions of said rules may be stored in a tree, where a node of such a tree corresponds to a data character chain or string, and branches from such a node correspond to the (according to the grammar rules) possible continuations of a data character string, where, in the case of, for example, text characters, every two branches differ in their first letter.

Such a tree can be expanded through the insertion of new grammar rules in that, starting from the root of the tree, a data character string corresponding to an expanded grammar rule is inserted into the tree.

When all the rules of the grammar have been inserted into the tree, said tree can be used for context compression.

In an example, an underlying text is parsed from beginning to end, with the goal of discovering that grammar rule which corresponds to the longest-possible prefix of the text. In other words, the longest prefix of the text is found for which there is a path within the tree, starting from the root of the tree. This is efficiently possible, because, at each node, there is no more than one corresponding branch for each letter.

The nodes of such a path can satisfy grammar rules in their entirety, or they can satisfy just a part of a rule. In this connection, the longest prefix corresponds to the last node of a path that satisfies a rule. Consequently, said rule can be applied, and the underlying algorithm is continued after the data character string that satisfies the rule. If no rule is discovered, the first terminal symbol of the text to be compressed is used and the algorithm is applied to the following text.

An alternative possibility of context compression consists in a procedure whereby the most frequent rules are found, this making it possible, in certain cases, to yet further reduce the storage space required for the resulting, compressed file.

Described hereinbelow are some examples of the effects and advantages that result for applications from what has been described hereinabove.

In databases, for example, most entries are relatively short and there is a high degree of redundancy over an entire column of a database table. In this case, it is possible to achieve a significantly good compression by creating a context grammar for such a column and by compressing the column using said context grammar.

In contrast to known database compression methods, it is possible in this case to compress globally over the column. In comparison with known table compression methods, which compress only entire entries, it is also possible to compress parts of column entries. Using a suitable recursive grammar, in which symbols refer to other symbols until, finally, the terminals are reached, this makes it possible to achieve excellent compression.

A different class of compression methods compresses the column entries individually. In the case of short database entries, as under consideration here, however, such methods result in no more than a small degree of compression.

The compression methods used in known databases such as Oracle or IBM DB2 differ fundamentally therefrom: the compression method used in Oracle works locally on pages, i.e. each time, a few lines of the table are compressed in one go. The method according to an embodiment of the invention, on the other hand, compresses the entries of an entire column. The compression used in IBM DB2 employs a global dictionary, the code word length being fixed at 12 bits. Context compression according to the method of an embodiment of the present invention, on the other hand, allows for variable code word length and the possibility that substrings can also be compressed. Although, in Oracle and other databases, it is also possible to compress individual database entries, for example using LZ77, this is worthwhile only for longer entries that contain redundancies. This type of compression cannot be profitably used in the application area of context compression (columns with short entries, where the entries of a column contain redundant parts).

A further area of application of the hereinbefore-described context compression is the compression of point-to-point connections in the case of data transfer, in order to increase the effectively usable bandwidth of such connections. Relatively short data packets of the kind that frequently occur especially in the case of data transfer are especially suitable for context compression. In contrast to the known standard methods, which are capable of exploiting the only the relatively small redundancy in a packet, context compression makes it possible for typical packet structures to be compressed highly efficiently.

Furthermore, referencing to, for example, one or—in the case one outward and one return transfer direction—two different context grammar(s), which are already available at both end points of a point-to-point connection, means that, frequently, referencing is made in the packets only to the rules contained in the context grammars. This differs drastically from the conventional methods, in which all the necessary information must be contained in each packet, which results in a further deterioration in the quality of compression.

The proposed context compression can, moreover, be adaptive in form, such that rules within context grammars are synchronously variable and/or renewable at the sending and receiving ends.

Also in the field of data storage, context compression using a context grammar can be employed to advantage for the compression of small files which, individually, are compressible only to a small extent, for example for the storage of many small files of identical type. An example of this is XML-formatted order forms or other data records of similar structure and composition.

While the invention has been particularly shown and described with reference to preferred embodiments thereof, it will be understood by those skilled in the art that various changes in form and details may be made therein without departing from the spirit and scope of the invention.

1-18. (canceled)

19. A method for electronically compressing and decompressing digital data using a context grammar, the method comprising:
grammatically compressing first digital data by discovering multiply occurring sequences of non-further-factorizable terminal symbols in the first digital data and replacing the discovered multiply occurring sequences of non-further-factorizable terminal symbols with non-terminal symbols that can be further factorized;
storing digital data belonging to the non-terminal symbols in a context grammar; and
compressing second digital data using the context grammar,
wherein the first digital data relates to a column of data stored in a database, and
wherein the second digital data relates to entries from the column of data stored in the database.

20. The method as recited in claim 19, further comprising producing the context grammar, wherein producing the context grammar comprises storing a derivation of each non-terminal symbol and wherein the derivation comprises a mapping for each non-terminal symbol onto a symbol from the non-terminal symbols in union with the terminal symbols.

21. The method as recited in claim 20, wherein the producing the context grammar further comprises producing a start symbol whose derivation corresponds to a text to be compressed.

22. The method as recited in claim 19, wherein the compressing second digital data using the context grammar further comprises importing grammar rules from the context grammar and storing expansions of the grammar rules in a tree structure.

23. The method as recited in claim 22, further comprising expanding the tree structure with new grammar rules obtained from the second digital data.

24. The method as recited in claim 22, wherein the expansions of the grammar rules include symbols, and
wherein the compressing second digital data using the context grammar further comprises traversing the tree structure symbol by symbol in ascending order and searching for a rule corresponding to a longest prefix, for which there is a tree path starting from a root of the tree structure.

25. The method as recited in claims 20, wherein the context grammar is produced according to a Sequential, a Sequitur, or a Repair algorithm.

26. The method as recited in claim 19, further comprising arithmetically coding the context grammar.

27. The method as recited in claim 19, further comprising arithmetically coding the context grammar using a Huffman code.

28. An apparatus for compressing and decompressing digital data using a context grammar comprising:
an electronic system for information processing, operative to:
grammatically compress first digital data by discovering multiply occurring sequences of non-further-factorizable terminal symbols in the first digital data and replacing the discovered multiply occurring sequences of non-further-factorizable terminal symbols with non-terminal symbols that can be further factorized;
store digital data belonging to the non-terminal symbols in a context grammar; and
compress second digital data using the context grammar,
wherein the first digital data relates to a column of data stored in a database, and
wherein the second digital data relates to entries from the column of data stored in the database.

29. A computer readable medium having stored thereon computer executable process steps operative to perform a method of compressing and decompressing digital data using a context grammar, the method comprising:
grammatically compressing first digital data by discovering multiply occurring sequences of non-further-factorizable terminal symbols in the first digital data and replacing the discovered multiply occurring sequences of non-further-factorizable terminal symbols with non-terminal symbols that can be further factorized;
storing digital data belonging to the non-terminal symbols in a context grammar; and
compressing second digital data using the context grammar,
wherein the first digital data relates to a column of data stored in a database, and
wherein the second digital data relates to entries from the column of data stored in the database.
